(19) United States
(12) Patent Application Publication
(10) Pub. No.: US 2008/0302365 A1
(43) Pub. Date: Dec. 11, 2008

(54) Respiratory Mask

(76) Inventors: Eric D. Cohen, Wellesley, MA (US); Robert W. Daly, Weston, MA (US); Christine M. Ciccone, Boston, MA (US); Daniel J. Braunstein, Arlington, MA (US); Allan Cameron, Natick, MA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/760,497

(22) Filed: Jun. 8, 2007

(51) Int. Cl. A62B 7/10; A62B 17/04

(52) U.S. Cl. 128/206.12; 128/201.24; 128/206.14

(57) ABSTRACT

A respiratory mask having a shell and a cushion that is adhered to a user's face is sufficiently rigid to provide dimensional stability and a constant volume between the respiratory mask and the user's face, while also being comfortable and conformable to a user's individual facial features. The respiratory mask may cover the nose, the mouth, or both of the user and is useful for respiratory therapies including sleep apnea. The respiratory mask may have a quick release mechanism such as a pull tab that tears a portion of the mask when pulled to allow access to the user's breathing passage or a pull string embedded in the adhesive that breaks the seal between the adhesive and the user's face when pulled.

### CROSS REFERENCE TO RELATED APPLICATIONS

This application contains subject matter which is related to co-pending U.S. patent application Ser. No. 11/405,948, titled “Method and System for Controlling Breathing,” filed on Apr. 17, 2006 and U.S. application Ser. No. 11/787,854, titled “Method and System for Controlling Breathing,” filed on Apr. 17, 2007, both of which are incorporated in their entirety by reference thereto.

### BACKGROUND OF THE INVENTION

1. Field of the Invention

The present invention is directed to a respiratory mask.

2. Background Art

Respiratory masks provide a gas or gases to a user in a variety of applications, including treatment of sleep apnea, anesthesiology, and to assist in breathing.

It is critical to many respiratory therapies to manage precisely the inhaled, mixed, and exhaled gases of a user, which may be achieved through a tight seal between the mask and the facial contours of the user. Leaks in the mask present a potential threat to anyone near the user as a result of leaked gases, and to the user himself for which specific amounts of gases and gas concentrations may be delivered based on the composition of gases assuming a tight seal. For example, when a respiratory mask is utilized in treating complex sleep apnea, a closed system is required to control the amount of carbon dioxide inhaled by the user.

In the past, a tight seal has been achieved through the use of straps and harnesses to pull the mask tightly against the user's face. Since facial geometries vary, the amount of force such straps and harnesses apply to generate an effective seal varies from person to person. In some instances, the force is so great it causes serious skin breakdown and damage to the face of the user as a result of reduced blood flow to the skin resulting from the pressing of the mask against the user's face. Therefore, it may be desirable to have a mask that conforms to a user's face and puts no pressure on the user's face while remaining safe and providing a sufficient seal.

Many respiratory therapies also have hoses and tubing connected to the mask to provide the gases. It may be desirable for the mask to be sufficiently rigid or stiff to provide a stable physical position and user perception of stability of the mask when in use, as the attached hoses and tubing may pull the mask in various directions. Stiffness and rigidity of the mask may also be important in maintaining a constant volume between the mask and the face of the user. For example, when a respiratory mask is utilized in treating complex sleep apnea, the mask is connected to a continuous positive airway pressure (CPAP) machine that provides positive air from the CPAP machine to the mask to help the wearer breathe consistently while sleeping. An important part of such a therapy is a closed system with a constant volume that controls the amount of carbon dioxide inhaled by the user.

A competing concern to the rigidity of a mask is its ability to conform to a user's individual facial features while providing comfort to the user. Compliance with continuous positive airway pressure therapy is reported to be less than 50% after one year, primarily as a result of mask discomfort. The ability of a mask to conform to a user's face comfortably is generally provided by a cushion. However, the cushion also serves to distribute forces applied to the mask such as pulling caused by the attached hoses and tubing, thereby limiting the degree of conformability and the degree of comfort. Therefore, it may be desirable to have a mask that is sufficiently rigid to provide stability and a constant volume, while also being comfortable and conformable to a user's individual facial features.

### BRIEF SUMMARY OF THE INVENTION

Disclosed herein is a respiratory mask having a cushion shaped to surround a breathing passage of a user having a first surface and a second surface, an adhesive disposed on the first surface of the cushion to adhere the cushion to the face of the user, a shell disposed on the second surface of the cushion, a port formed in the shell, and a pull tab disposed on the respiratory mask. When the pull tab is pulled, at least a portion of the respiratory mask is torn to at least partially remove the portion to allow access to the breathing passage of the user.

Also disclosed herein is a respiratory mask having a cushion shaped to surround a breathing passage of a user having a first surface and a second surface, an adhesive disposed on the first surface of the cushion to adhere the cushion to the face of the user, a shell disposed on the second surface of the cushion, a port formed in the shell, and a string embedded in the adhesive. At least one end of the string is accessible to the user when in use such that when the user pulls the string, a seal between the adhesive and the user's face is broken and the respiratory mask may be easily removed.

Also disclosed herein is a respiratory mask having a cushion shaped to surround a breathing passage of a user having a first surface, a second surface, and a flange extending from the first surface of the cushion dividing the surface into a first section and a second section, an adhesive for adhering the cushion to the face of a user disposed on the first section of the first surface, a groove formed between the flange and the second section of the surface such that sheer forces are minimized when positive pressure is applied to the respiratory mask, a shell disposed the second surface of the cushion, and a port formed in the shell.

Also disclosed herein is a respiratory mask having a cushion shaped to surround a breathing passage of a user having a first surface and a second surface, an adhesive disposed on the first surface of the cushion to adhere the cushion to the face of the user, a shell disposed on the second surface of the cushion, and a port formed in the shell. The shell is sufficiently rigid to provide dimensional stability and a constant seal between said respiratory mask and a face of a user.

Also disclosed herein is a respiratory mask having a cushion shaped to surround at least the mouth of a user having a first surface and a second surface, an adhesive disposed on the first surface of the cushion to adhere the cushion to a user's face including the chin of a user to prevent a user's mouth from opening, a shell disposed on the second surface of the cushion, and a port formed in the shell.

### BRIEF DESCRIPTION OF THE DRAWINGS/FIGURES

FIG. 1 is a front view of an exemplary respiratory mask.

FIG. 2 is a rear view of the exemplary respiratory mask of FIG. 1.

FIG. 3 is a cross-sectional side view of one embodiment of the exemplary respiratory mask of FIG. 1.

FIG. 4 is a cross-sectional side view of an alternative embodiment of the exemplary respiratory mask of FIG. 1.

FIG. 4a is an enlarged view of the circled section of FIG. 4.

FIG. 4b is a cross-section view of the exemplary respiratory mask of FIG. 4 when attached to the face of a user.

FIG. 5 is a front view of an alternative exemplary respiratory mask.

FIG. 6 is a rear view of the exemplary respiratory mask of FIG. 5.

FIG. 7 is a cross-sectional side view of one embodiment of exemplary respiratory mask of FIG. 5.

FIG. 8 is front view of an exemplary respiratory mask with a quick removal mechanism.

FIG. 9 is front view of an exemplary respiratory mask with an alternative quick removal mechanism.

FIG. 10 is a side view of an exemplary respiratory mask attached to the face of a user.

FIG. 11 is a perspective view of an exemplary shell.

FIG. 12 is a cross-sectional view of an alternative embodiment of exemplary respiratory mask of FIG. 5 when attached to the face of a user.

FIG. 13 is a rear view of an exemplary respiratory mask having an exemplary stiffening insert.

FIG. 14 is a front view of an exemplary respiratory mask having a notch in the cushion.

### DETAILED DESCRIPTION OF THE INVENTION

Disclosed herein is a respiratory mask shaped to surround a breathing passage of a user, including the nose, the mouth, or both, that is tightly sealed to the user's face, preferably utilizing an adhesive.

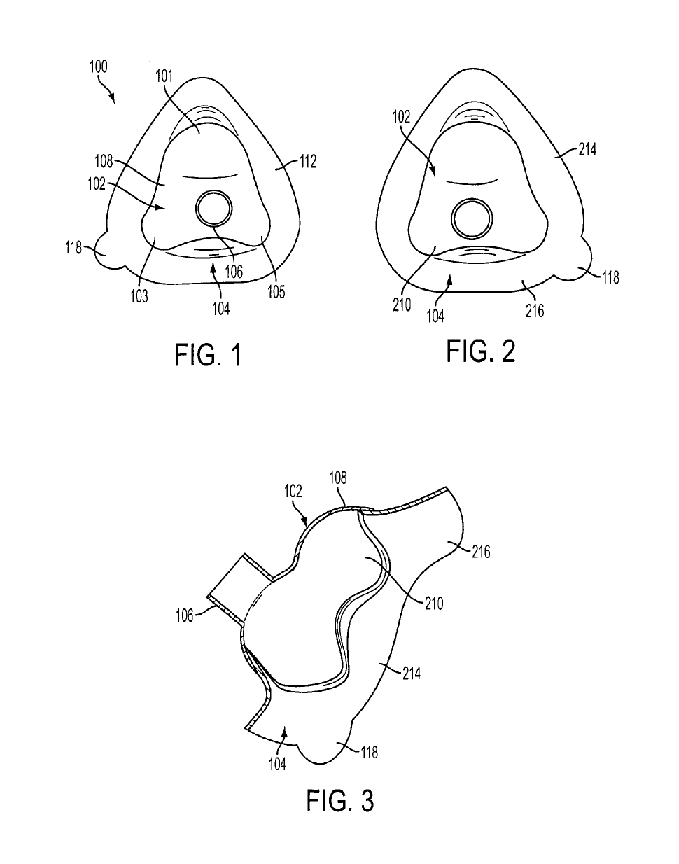

As shown in FIGS. 1-3, in one embodiment of the present invention a respiratory mask 100 includes a shell 102 disposed on a cushion 104. Shell 102 may have a first surface 108 facing an exterior of mask 100 and a second surface 210 facing an interior of mask 100. A port 106 may extend from first surface 108 of mask 100 to provide a connection for a hose or tubing connected to a CPAP machine, breathing machine, an anti-asphyxiation valve or other respiratory aid or therapy device. Shell 102 may be made of a rigid and transparent material including, but not limited to, polypropylene, polystyrene, and/or polycarbonate.

In certain embodiments of the present invention, it may be advantageous for the material of shell 102 to be sufficiently rigid to maintain a consistent interior volume of space in the interior of the mask 100 between mask 100 and the face of the user. Maintaining a consistent volume is critical to many respiratory therapies that require a constant volume in calculating the amount of drugs or gases delivered thereto. The constant volume may be, but is not limited to, less than about 100 ml. Shell 102 maintains its geometry despite externally applied forces to shell 102 such as when a user sleeps on his side or from shell 102 being pulled by hoses or tubes connected to port 106. Shell 102 may have lobes 101, 103, and 105, which when connected generally form the shape of a triangle, that provide structural stability to mask 100.

In an embodiment of the present invention, the material of shell 102 may be transparent such that others may determine if the user (e.g. an elderly patient) is breathing or if the user has vomited into mask 100.

Cushion 104 may have a first surface 112, at least a portion of which contacts second surface 210 of shell 102 and/or first surface 108 of shell 102, and a second surface 214, at least a portion of which directly or indirectly contacts the skin of a user. A portion of second surface 214 of cushion 104, which contacts the skin of a user may have an adhesive 216. Adhesive 216 may be a medical adhesive including, but not limited to a pressure sensitive adhesive, such as, for example, 3M-1509 double sided medical tape available from 3M Co. St. Paul, Minn., that allows mask 100 to be sealed to a user's face without the use of straps that when tightened may exert high forces on the user's skin and cause discomfort and/or skin trauma. The strength of adhesive 216 may increase over time and may be able to adhere to a user's face for at least 8 hours. Cushion 104 may also have one or more tabs 118 that a user may grip to aid in peeling off or otherwise removing mask 100. When adhesive 216 is a double sided tape, it may be adhered to cushion 104 first and then to the face of the user, or alternatively it may be applied to the face of the user first and then cushion 104 of mask 100 may be adhered to adhesive 216.

The material for cushion 104 may be a soft and compliant material including, but not limited to, a thermoplastic elastomer or thermoplastic urethane, such that cushion 104 conforms to the user's facial contours. In this manner, cushion 104 may provide comfort to the user and maintain a proper seal while fitting a variety of facial contours without customization. Adhesive 216 and the compliant nature of cushion 104 may provide mask 100 with a substantially leak proof seal.

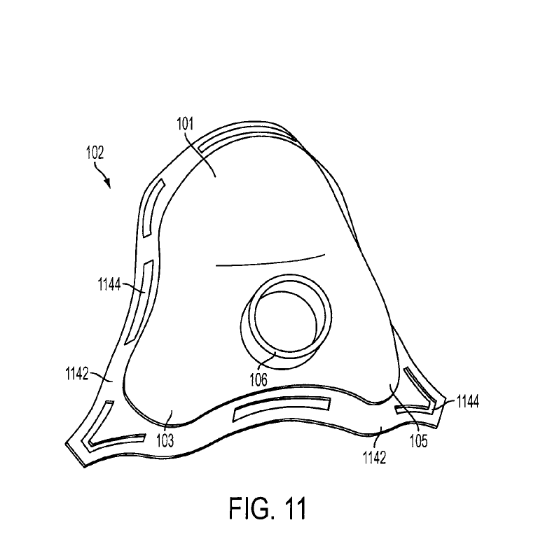

Shell 102 and cushion 104 may both be molded and may be co-molded utilizing standard techniques including, but not limited to, overmolding and two shot injection molding. When cushion 104 is overmolded onto shell 102, shell 102 may have an outer flange 1142 extending from its periphery with a plurality of openings 1144, as shown in FIG. 11, such that cushion 104 may be molded around shell 102. During the molding process, the material for cushion 104 would flow through openings 1144 in flange 1142 of shell 102 and engulf flange 1142, thereby connecting shell 102 to cushion 104.

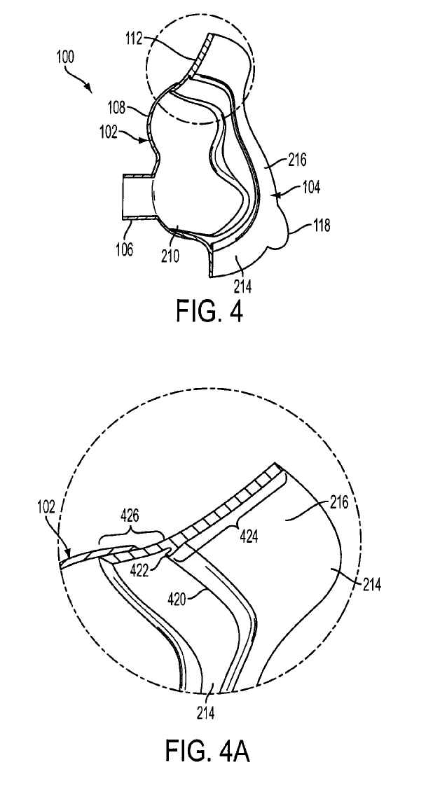

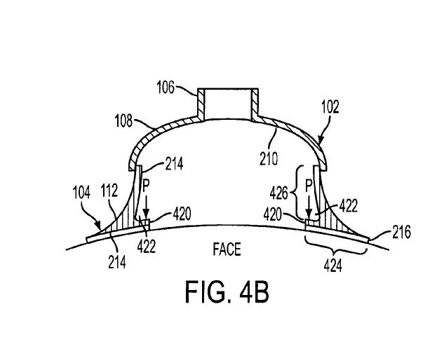

Mask 100, as shown in FIGS. 4 and 4a, may have a feature to prevent mask 100 from peeling off the face of the user as a result of sheer forces applied to the interior of mask 100. Cushion 104 may have a flange 420 extending outward from second surface 214 of cushion 104. Flange 420 may divide second surface 214 of cushion 104 into a first section 424 and a second section 426. First section of 424 of second surface 214 of cushion 104 has adhesive 216 applied thereto and contacts the skin of the user. A groove 422 may be formed between flange 420 and second section 426 of second surface 214 of cushion 104.

As shown in FIG. 4b, when mask 100 with flange 420 is applied to face of a user, an angle of groove 422 between flange 420 and second section 426 of second surface 214 of cushion 104 increases. When positive pressure is applied to an interior of mask 100, the pressure may create a sheer force parallel to a line of tangency between the user's skin and cushion 104 that causes adhesive 216 on cushion 104 to shift and peel mask 100 from the user's face. However, when flange 420 is present, positive pressure P present in the area of groove 422 exerts a force on flange 420 normal to the skin of the user, forcing flange 420 and adhesive 216 thereon against the skin of the user, thereby reinforcing the seal of mask 100 to the user's face. Flange 420 may have a tapered thickness such that it is thickest where connected to cushion 104 and thinnest at its edge. A tapered flange 420 allows flange 420 to flex against the skin of the user independent of a remainder of cushion 104, which permits a force P to act normal to the face of the user thereby minimizing peeling forces that would separate the mask from the face. The pressure exerted on flange 420 normal to the face allows for an adhesive that may have lower adhesion properties and thus reduce any user discomfort that may occur if a more aggressive adhesive were necessary.

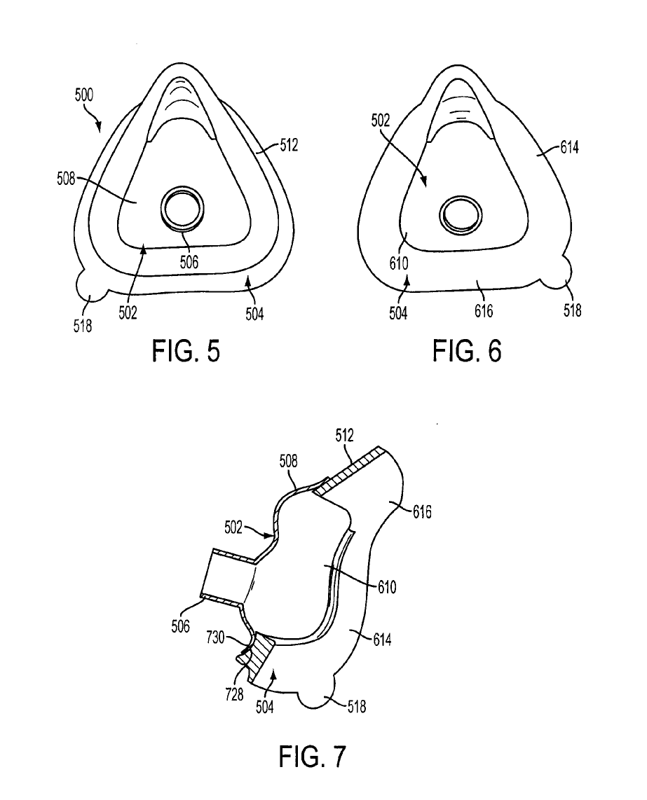

An alternative respiratory mask 500, as shown in FIGS. 5-7, may have a shell 502 disposed on a cushion 504. Shell 502 may have a first surface 508 facing an exterior of mask 500 and a second surface 610 facing an interior of mask 500. A port 506 may extend from first surface 508 of mask 500 to provide a connection for a hose or tubing connected to a CPAP machine, breathing machine, an anti-asphyxiation valve or other respiratory aid or therapy device. Shell 502 may be made of a rigid and transparent material including, but not limited to, polypropylene, polystyrene, and/or polycarbonate in order to have the same advantages as discussed above with reference to shell 102. Shell 502 may have lobes (not shown) similar to lobes 101, 103, and 105 in shell 102, which when connected generally form the shape of a triangle, that provide structural stability to mask 500.

Cushion 504 may have a first surface 512, a portion of which contacts second surface 610 of shell 502, and a second surface 614, a portion of which contacts the skin of a user. A portion of second surface 614 of cushion 504, which contacts the skin of a user may have an adhesive 616. Adhesive 616 may be a medical adhesive including, but not limited to a pressure sensitive adhesive, such as, for example, 3M-1509 double sided medical tape available from 3M Co. St. Paul, Minn., that allows mask 500 to be sealed to a user's face without the use of straps that when tightened may exert high forces on the user's skin and cause skin trauma. The strength of adhesive 616 may increase over time and may be able to adhere to a user's face for at least 8 hours. Cushion 504 may also have one or more tabs 518 that a user may grip to aid in peeling off or otherwise removing mask 500. In one embodiment, adhesive 616 may comprise double sided tape. When adhesive 616 is a double sided tape, it may be adhered to cushion 504 first and then to the face of the user, or alternatively it may be applied to the face of the user first and then cushion 504 of mask 500 may be adhered to adhesive 616.

The material for cushion 504 may be soft and compliant including, but not limited to, a foam, a thermoplastic elastomer, or thermoplastic urethane, such that cushion 504 conforms to the user's facial contours. When cushion 504 is a foam, the foam may be a substantially impermeable elastomer foam, for example a closed-cell, cross-linked polyester foam or may be a permeable elastomer foam, for example an open-cell foam. If an open-cell foam is utilized as the cushion, the exterior of the cushion may be sealed with a membrane of impermeable material including, but not limited to thermoplastic urethane or thermoplastic elastomer. Alternatively, a coating may be sprayed into a mold when forming an open-cell foam cushion to form a “skin” thereon. When cushion 504 is a thermoplastic elastomer or thermoplastic urethane, cushion 504 may be a solid molded material or may be a bladder made of thermoplastic elastomer or thermoplastic urethane filled with a fluid. In this manner, cushion 504 may provide comfort to the user and maintain a proper seal while fitting a variety of facial contours without customization. Adhesive 616 and the compliant nature of cushion 504 provides mask 500 with a substantially leak proof seal.

First surface 512 of cushion 504 may have a concave channel 728 formed thereon for receiving a flange 730 extending from a perimeter of shell 502. An adhesive may be applied to channel 728 of cushion 504 or flange 730 of shell 502 to adhere shell 502 to cushion 504. The adhesive used to bond shell 502 to cushion 504 may be weaker in strength than adhesive 616 used to bond mask 500 to the user's face such that shell 502 may be pulled apart from cushion 504 and cushion 504 remains sealed to the user's face, yet strong enough to maintain a tight seal between shell 502 and cushion 504 during operation. In an embodiment of the present invention, a portion of flange 730 of shell 502 may extend past cushion 504 to provide a grip for pulling shell 502 off of cushion 504. The adhesives may be the same or different depending upon the materials of shell 502 and cushion 504. In this manner, mask 500 may provide immediate access to a user's breathing passages if needed. Cushion 504 may then be removed at a later time. In such an instance, shell 502 may be utilized multiple times in conjunction with a plurality of single use cushions 504. This feature may also be realized by having other mechanical interlocks between shell 502 and cushion 504 including, but not limited to, a zipper or hook and loop fasteners.

Flange 730 of shell 502 allows for shell 502 to be utilized in load distribution. Flange 730 may be substantially parallel to the user's skin such that any load or forces applied to shell 502, such as pulling caused by hoses and tubing attached to port 506, are distributed by flange 730. This minimizes the amount of forces cushion 504 needs to distribute, thereby allowing cushion 504 to have greater conformability and to be more comfortable. Utilizing shell 502 with flange 728 also has an added benefit of minimizing the dead space (interior volume) of mask 500 giving mask 500 a lower profile, which may be more aesthetically pleasing to a user. Flange 730 may be shaped to apply to a flat surface of cushion 504 or to a curved channel 728 in cushion 504. Curved channel 728 allows for increased rigidity of shell 502 around its perimeter by preventing bending of shell 502. In addition, the increased rigidity of the perimeter of shell 502 gained through the combination of curved channel 728 and flange 730 allows shell 502 to act as a sling for the jaw of the user to keep the user's mouth in a closed or semi-closed position, as discussed in more detail below.

In an embodiment of the invention, flange 730 of shell 502 may also have a plurality of holes or perforations as discussed above with reference to FIG. 11 such that cushion 504 may be molded around shell 502. During the molding process, the material for cushion 504 would flow through the holes in flange 730 of shell 502 and engulf flange 730 and thereby connect shell 502 to cushion 504. In case immediate access is needed to a user's breathing passages, this arrangement may allow shell 502 to be ripped from cushion 504, leaving cushion 504 connected to the user's skin. It is contemplated that the plurality of holes may be provided either with or without adhesives to provide the required connection between shell 502 and cushion 504.

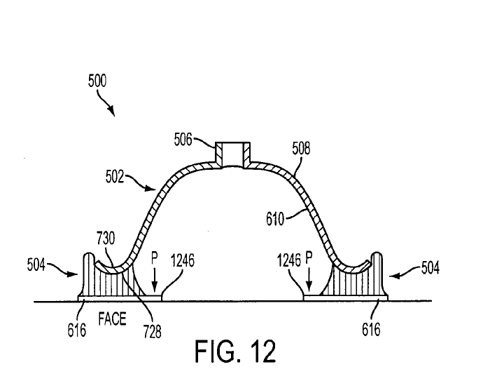

Mask 500, as shown in FIG. 12, may have a feature to prevent mask 500 from peeling off the face of the user as a result of sheer forces applied to the interior of mask 500. Adhesive 616 may be in the form of a tape and extend inward past cushion 504 to form an adhesive flange 1246. When positive pressure is applied to an interior of mask 500, the pressure may create a sheer force parallel to a line of tangency between the user's skin and cushion 504 that causes adhesive 616 on cushion 504 to shift and peel mask 500 from the user's face. However, when adhesive flange 1246 is present, positive pressure present in mask 500 exerts a force P on adhesive flange 1246 normal to the skin of the user, forcing adhesive flange 1246 against the skin of the user, thereby reinforcing the seal of mask 500 to the user's face.

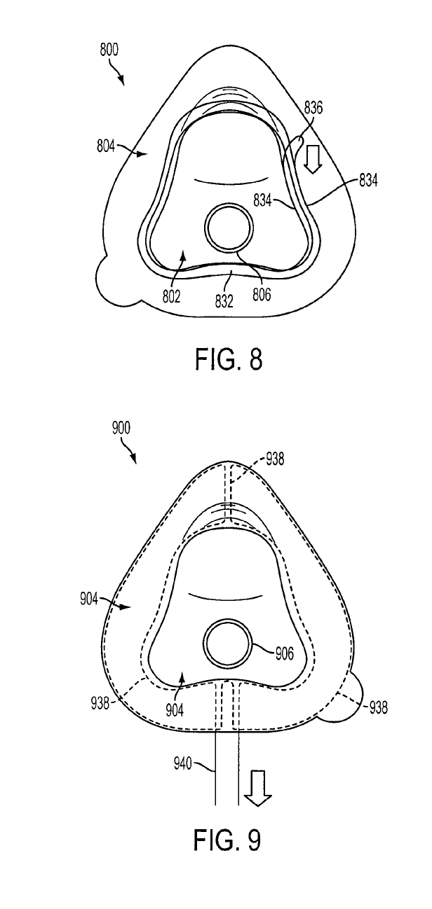

As discussed above, it is sometimes necessary to quickly remove a respiratory mask in case of a medical emergency or panic attack, and slowly peeling an adhesive from the skin of a user is less desirable. FIG. 8 shows one mechanism for providing an emergency removal that may be incorporated into either mask 100 or mask 500. Mask 800 may have a shell 802, having a port 806, disposed on a cushion 804. Mask 800 may have a pull tab 832 disposed on mask 800. Pull tab 832 may comprise a thin strip of material having two edges of perforation or weakness 834 thereon and an end 836. When end 836 is grasped and pulled, lines of perforations or weakness 834 are torn, thereby removing pull tab 832 from mask 800. Pull tab 832 may extend around a periphery of a portion of mask 800 to allow an entire piece of mask 800 to be removed providing access to the user's breathing passage(s) and leaving a remainder of mask 800 still adhered to the user's skin. Alternatively, pull tab 832 may extend about a portion of a mask 800 to allow a portion of mask 800 to be removed creating a flap which may be folded over to provide access to the user's breathing passage(s) and mask 800 remains adhered to the skin of the user.

Pull tab 832 may be formed in shell 802 or at an interface between shell 802 and cushion 804. In such an instance, pull tab 832 may be the same material as shell 802. Pull tab 832 may also be formed in cushion 804 when cushion 804 is a thermoplastic elastomer or thermoplastic urethane such as in cushion 104. In such an instance, pull tab 832 may be the same material as cushion 104.

FIG. 9 shows an alternative mechanism for providing an emergency removal that may be incorporated into either mask 100 or mask 500. Mask 900 may have a shell 902, having a port 906, disposed on a cushion 904. Mask 900 may have a string 938 embedded in at least a portion of adhesive 216 or 616. String 938 may include a free end 940 which may be accessed while mask 900 is in use. When required, free end 940 of string 938 may be pulled, thereby causing string 938 to break the seal between adhesive 216 or 616 and the user's face such that mask 900 may be removed in its entirety. String 938 may extend around substantially an entire inner and outer border of adhesive 216 or 616. The material for string 938 may be a lubricous material including, but not limited to, polytetrafluoroethylene, polyester, and nylon. Alternatively, string 938 may be coated in a medically safe and lubricous material, such as, for example, wax.

It is noted that while respiratory masks 100, 500, 800, and 900 are shaped to surround a user's mouth and nose, respiratory masks that are shaped to surround only the mouth or only the nose are also within the scope of the present invention.

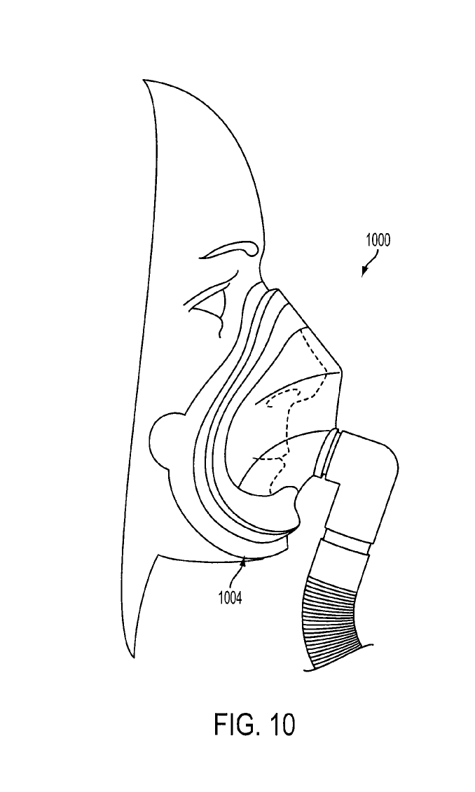

Embodiments of the present invention in which the mask surrounds a user's mouth may be shaped such that the mask may be adhered below the user's lower lip on his chin. This positioning of the respiratory mask keeps the mouth and jaw of the user in a more forward and natural position and in a closed or semi-closed position. As shown in FIG. 10, respiratory mask 1000 is shaped to surround a user's mouth and nose and a lower portion of cushion 1004 rests on the chin of the user. There are many situations when keeping a patient's mouth closed in advantageous in the delivery of gases and in aiding ventilation. Many ventilation and gas therapies are more effective when delivered through the nose and keeping a patient's mouth closed reduces the pressure required for a CPAP machine when treating sleep apnea and reduces the amount of gases delivered. Keeping the mouth and jaw forward and in a closed or semi-closed position may improve the therapeutic value of breathing therapies for sleep apnea patients, as it increases airway caliber and decreases airway resistance in comparison to current appliances that use chin, head, or jaw straps and harnesses to keep the mouth closed through pulling the jaw backward, thereby restricting the airway. The use of adhesive to seal the mask to the user's face, the stiffness and geometry of the mask, and/or the use of the user's facial features keeps the mouth and jaw in this position without the use of cumbersome straps, harnesses, or chin supports.

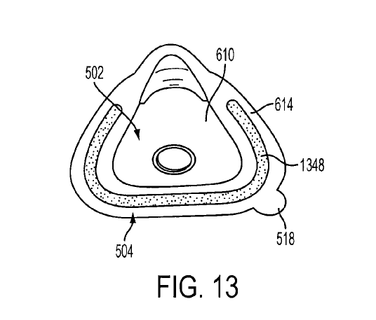

Embodiments of the present invention, as shown in FIG. 13, may have an insert 1348 for providing additional dimensional stability to mask positioned within a recess (not shown) on second surface 614 of cushion 504. Insert 1348 may be flush with second surface 614 of cushion 1304 and an adhesive (not shown), such as a double sided tape similar to adhesive 616, may be applied to second surface 614 of cushion 504 and insert 1348. Alternatively, insert 1348 may be embedded within cushion 504. Insert 1348 may comprise, for example, a strip of polyester. Insert 1348 may be stiff enough not to deform easily in the plane of the user's face while being sufficiently flexible in the plane normal to the face to lay comfortably on a variety of facial topologies. Insert 1348 may be horseshoe shaped to go under the mouth and up either side of the mouth and nose of the user, thereby providing a sling for the jaw to keep the user's mouth in the closed or semi-closed position as discussed above.

Embodiments of the present invention in which the mask surrounds the nose may be shaped such that when the mask is placed over the nose and adhered to the nose, the mask spreads the exterior nasal skin to open and keep open the nasal cavity to improve breathing.

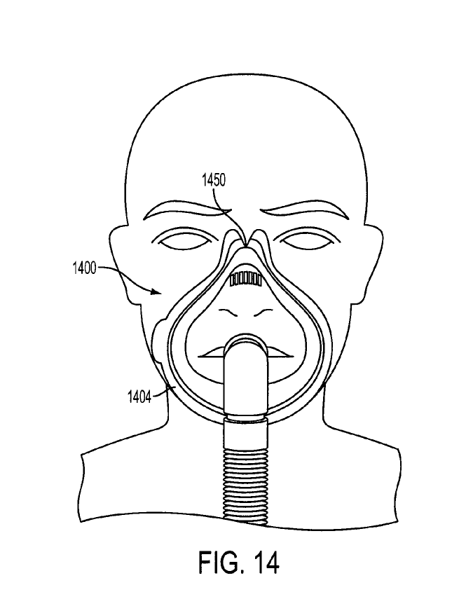

Embodiments of the present invention, as shown in FIG. 14, may include a mask 1400 having a cushion 1404 with a notch 1450 located in a region of cushion 1404 corresponding to the bridge of the nose of a user. Notch 1450 may be v-shaped and may be cut or molded into cushion 1404. Material for cushion 1404 includes, but is not limited to, a foam, a thermoplastic elastomer, or a thermoplastic urethane. Notch 1450 provides a better fit around the nose of the user, lowers the profile of the mask, and when applied to the nose, creates a compound surface to increase the sealing surface area.

Embodiments of the present invention may increase compliance of a patient with his respiratory therapies because they are more comfortable than previous masks. Embodiments of the present invention may be lightweight to increase the user's mobility and to decrease the uncomfortable feeling of a heavy mask on the face, both of which increase compliance.

Respiratory masks of the present invention may be utilized in pressured, non-pressured, negative pressured environments as well as during alternating pulsing of positive and negative pressures.

Respiratory masks of the present invention may be discarded after each use to avoid the need to clean the mask after each use and may be manufactured in a cost effective manner so they are competitive and affordable in relation to reusable masks.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A respiratory mask, comprising:
a cushion shaped to surround a breathing passage of a user, said cushion having a first surface and a second surface;
an adhesive disposed on said first surface of said cushion to adhere said cushion to the face of the user;
a shell disposed on said second surface of said cushion;
a port formed in said shell; and
a pull tab disposed on said respiratory mask wherein when said pull tab is pulled, at least a portion of said respiratory mask is torn to at least partially remove said portion to allow access to the breathing passage of the user.

2. The respiratory mask of claim 1, wherein said pull tab is disposed on said shell.

3. The respiratory mask of claim 1, wherein said pull tab is disposed on said cushion.

4. The respiratory mask of claim 1, wherein said pull tab is disposed at an interface between said shell and said cushion.

5. The respiratory mask of claim 1, wherein said shell is transparent.

6. The respiratory mask of claim 1, wherein said adhesive is a double sided tape.

7. A respiratory mask, comprising:
a cushion shaped to surround a breathing passage of a user, said cushion having a first surface and a second surface;
an adhesive disposed on said first surface of said cushion to adhere said cushion to the face of a user;
a shell disposed on said second surface of said cushion;
a port formed in said shell; and
a string embedded in said adhesive wherein at least one end of said string is accessible to the user when in use such that when the user pulls said string, a seal between said adhesive and the user's face is broken and said respiratory mask may be removed.

8. The respiratory mask of claim 7, wherein said string is selected from the group consisting of polytetrafluoroethylene, polyester, and nylon.

9. The respiratory mask of claim 7, wherein said shell is transparent.

10. The respiratory mask of claim 7, wherein said adhesive is a double sided tape.

11. A respiratory mask, comprising:
a cushion shaped to surround a breathing passage of a user, said cushion having a first surface, a second surface and a flange extending from said first surface such that positive pressure present in an interior of said respiratory mask exerts a force on said flange normal to the skin of a user, forcing said flange against the skin of a user, thereby reinforcing a seal of said respiratory mask to the face of a user;
an adhesive for adhering said cushion to the face of a user disposed on said first surface;
a shell disposed on said second surface of said cushion; and
a port formed in said shell.

12. The respiratory mask of claim 11, wherein:
said flange is part of said cushion and divides said first surface of said cushion into a first section and a second section forming a groove between said flange and said second section of said first surface; and
said adhesive is disposed on said first section of said first surface of said cushion.

13. The respiratory mask of claim 12, wherein said flange is movable to change an angle of said groove between said flange and said second section of said first surface.

14. The respiratory mask of claim 11, wherein said adhesive is a double sided tape and said flange is part of said adhesive that extends inward past said first surface of said cushion.

15. The respiratory mask of claim 11, wherein said shell provides dimensional stability to maintain a constant volume between said respiratory mask and a face of a user.

16. The respiratory mask of claim 11, further comprising an emergency removal mechanism.

17. The respiratory mask of claim 16, wherein said emergency removal mechanism is a pull tab disposed on said respiratory mask wherein when said pull tab is pulled, at least a portion of said respiratory mask is torn to at least partially remove said portion to allow access to said breathing passage of the user.

18. The respiratory mask of claim 16, wherein said emergency removal mechanism is a string embedded in said adhesive wherein at least one end of said string is accessible to the user when in use such that when the user pulls said string, a seal between said adhesive and the user's face is broken and said respiratory mask may be easily removed.

19. The respiratory mask of claim 11, wherein said adhesive is a double sided tape.

20. A respiratory mask, comprising:
a cushion shaped to surround a breathing passage of a user, said cushion having a first surface and a second surface;
an adhesive disposed on said first surface of said cushion to seal said cushion to a user's face; and
a shell disposed on a second surface of said cushion, wherein said shell is sufficiently rigid to provide dimensional stability and a constant volume between said respiratory mask and a face of a user; and
a port formed in said shell.

21. The respiratory mask of claim 20, wherein said constant volume is less than 100 ml.

22. The respiratory mask of claim 20, wherein said shell comprises a flange extending around a perimeter of said shell such that said flange contacts said second surface of said cushion.

23. The respiratory mask of claim 22, wherein said flange is substantially parallel to the skin of a user when said respiratory mask is sealed to the face of a user.

24. The respiratory mask of claim 22, wherein said second surface of said cushion comprises a concave channel that receives said flange of said shell.

25. The respiratory mask of claim 24, wherein said flange is substantially parallel to the skin of a user when said respiratory mask is sealed to the face of a user.

26. The respiratory mask of claim 20, wherein said respiratory mask surrounds the nose of a user and said cushion has a notch corresponding to a region of said cushion that covers the bridge of the nose of a user.

27. The respiratory mask of claim 20, wherein said respiratory mask surrounds the nose of a user and said cushion is shaped such that when said respiratory mask is placed over the nose and adhered to the nose, the mask spreads the exterior nasal skin to open and keep open the nasal cavity.

28. The respiratory mask of claim 20, further comprising an emergency removal mechanism.

29. The respiratory mask of claim 28, wherein said emergency removal mechanism is a pull tab disposed on said respiratory mask wherein when said pull tab is pulled, at least a portion of said respiratory mask is torn to at least partially remove said portion to allow access to said breathing passage of the user.

30. The respiratory mask of claim 28, wherein said emergency removal mechanism is a string embedded in said adhesive wherein at least one end of said string is accessible to the user when in use such that when the user pulls said string, a seal between said adhesive and the user's face is broken and said respiratory mask may be easily removed.

31. The respiratory mask of claim 20, wherein said adhesive is a double sided tape.

32. A respiratory mask, comprising:
a cushion shaped to surround at least the mouth of a user, said cushion having a first surface and a second surface;
an adhesive disposed on a first surface of said cushion to seal said cushion to a user's face including the chin of a user to prevent a user's mouth from opening;
a shell disposed on a second surface of said cushion; and
a port formed in said shell.

33. The respiratory mask of claim 32, wherein said shell comprises a flange extending around a perimeter of said shell such that said flange contacts said second surface of said cushion.

34. The respiratory mask of claim 33, wherein said flange is substantially parallel to the skin of a user when said respiratory mask is sealed to the face of a user.

35. The respiratory mask of claim 33, wherein said second surface of said cushion comprises a concave channel that receives said flange of said shell.

36. The respiratory mask of claim 35, wherein said flange is substantially parallel to the skin of a user when said respiratory mask is sealed to the face of a user.

37. The respiratory mask of claim 33, wherein said cushion has a stiffening insert that acts as a sling for the jaw of the user.

38. The respiratory mask of claim 32, wherein said respiratory mask surrounds the nose of a user and said cushion has a notch corresponding to a region of said cushion that covers the bridge of the nose of a user.

39. The respiratory mask of claim 32, wherein said respiratory mask surrounds the nose of a user and said cushion is shaped such that when said respiratory mask is placed over the nose and adhered to the nose, the mask spreads the exterior nasal skin to open and keep open the nasal cavity.

40. The respiratory mask of claim 32, wherein said shell provides dimensional stability to maintain a constant volume between said respiratory mask and a face of a user.

41. The respiratory mask of claim 32, further comprising an emergency removal mechanism.

42. The respiratory mask of claim 41, wherein said emergency removal mechanism is a pull tab disposed on said respiratory mask wherein when said pull tab is pulled, at least a portion of said respiratory mask is torn to at least partially remove said portion to allow access to said breathing passage of the user.

43. The respiratory mask of claim 41, wherein said emergency removal mechanism is a string embedded in said adhesive wherein at least one end of said string is accessible to the user when in use such that when the user pulls said string, a seal between said adhesive and the user's face is broken and said respiratory mask may be easily removed.

44. The respiratory mask of claim 32, wherein said cushion also surrounds the nose of a user.

45. The respiratory mask of claim 32, wherein said adhesive is a double sided tape.
